(19) United States
(12) Patent Application Publication
(10) Pub. No.: US 2012/0219701 A1
(43) Pub. Date: Aug. 30, 2012

(54) METHOD FOR FABRICATING TOUCH SENSOR STRUCTURE

(75) Inventor: CHIEN-HAO WU, New Taipei City (TW)

(73) Assignee: HANNSTAR DISPLAY CORPORATION, NEW TAIPEI CITY (TW)

(21) Appl. No.: 13/212,166

(22) Filed: Aug. 17, 2011

(30) Foreign Application Priority Data
Feb. 25, 2011 (TW) 100106429

(51) Int. Cl. B05D 5/12; B05D 3/02; B05D 1/38; B05D 3/00

(52) U.S. Cl. 427/58

(57) ABSTRACT

A method for fabricating a touch sensor structure is disclosed and has steps of forming a conductive layer on a substrate; forming a patterned bridging photo-resist layer on the conductive layer through a half-tone masking process that the bridging photo-resist layer partially covers the conductive layer and has a first portion and a relatively thinner second portion; removing a portion of the conductive layer which is not covered by the bridging photo-resist layer to pattern the conductive layer; and removing the second portion of the bridging photo-resist layer to form a bridging layer and the patterned conductive layer is partially exposed to be a conductive-wire layer. Hence the present invention reduce one masking process during forming conducting wires and bridge structures and provides better production efficiency.

### FIELD OF THE INVENTION

The present invention relates to a method for fabricating a touch sensor structure, and more particularly to a method for fabricating a touch sensor structure that reduces one masking process.

### BACKGROUND OF THE INVENTION

With reference to FIG. 1, FIG. 1 discloses a side view of a conventional capacitive touch sensor structure, which includes a glass substrate 80, a metal wire layer 81, a photo-resist layer 82, a transparent conductive layer 83 and a protection layer 84 stacked in orders. With reference to FIG. 2, FIGS. 3a to 3f and FIGS. 4a to 4d, which disclose a manufacturing process of the aforementioned touch sensor structure that firstly forms a metal layer 90′ on the glass substrate 80 by sputtering (as shown in FIG. 3 (a)); then forms a photo-resist layer, which turns into a patterned photo-resist layer 900 (as shown in FIG. 3(b)) after exposure and developing procedures; then removes a part of the metal layer 90′ that is not covered by the photo-resist layer 900 by etching (as shown in FIG. 3(c)); and then forms a metal wire layer 90 having a predetermined wiring pattern by removing the patterned photo-resist layer 900 (as shown in FIG. 3(d)).

The manufacturing process then coats the metal wire layer 90 with a bridging photo-resist layer 91 (as shown in FIG. 3(e)); and then coats with a transparent conductive layer 92′ and a photo-resist layer 920 (as shown in FIGS. 3(f) and 4(a)); and then forms a touch sensing conductive layer 92 having predetermined patterns after photo-resist etching and stripping procedures (as shown in FIGS. 4(b) and 4(c)), wherein the patterned touch sensing conductive layer 92 has X-axis and Y-axis touch-sensing units, and the X-axis touch-sensing units are electrically connected to each other via the metal wire layer 90, and the Y-axis touch-sensing units are directly connected in series and separated from the X-axis touch-sensing units by the bridging photo-resist layer 91; and lastly coats a complete protection layer 93, and thereby completes the manufacture of the aforementioned capacitive touch sensor structure (as shown in FIG. 4(d)).

The manufacture of the foregoing touch sensing structure requires several masking processes to form patterned photo-resist, wherein forming the bridging photo-resist layer 91 requires passing through steps of removing photo-resist layer 900 for forming metal wire and coating a new photo-resist layer to form the bridging photo-resist layer 91 and includes two masking processes. However, if a photo-resist layer for bridging can be formed through one masking process, efficiency of producing the foregoing touch sensor structure will be remarkably enhanced.

Hence, it is necessary to provide a method for fabricating a touch sensor structure to overcome the problems existing in the conventional technology.

### SUMMARY OF THE INVENTION

In consideration of the shortcomings of prior art, a primary object of the invention is to provide a method for fabricating a touch sensor structure, wherein one masking process is reduced during forming conducting wires and bridging structures while comparing with the conventional method for manufacturing a touch sensor structure, and thereby relatively have a better production efficiency.

To achieve foregoing object, the present invention provides a method for fabricating a touch sensor structure, which has following steps of:

forming a conductive layer on a substrate;

forming a bridging photo-resist layer on the conductive layer, wherein the bridging photo-resist layer partially covers the conductive layer, and the bridging photo-resist layer has a first portion and a second portion, and the thickness of the second portion is thinner than the thickness of the first portion;

removing a portion of the conductive layer which is not covered by the bridging photo-resist layer to form a patterned conductive layer, wherein an edge of the bridging photo-resist layer is substantially aligned with an edge of the patterned conductive layer;

removing the second portion of the bridging photo-resist layer to form a bridging layer and the patterned conductive layer is partially exposed to form a conductive-wire layer;

softening the bridging layer by a baking process;

forming a transparent conductive layer on the substrate to cover the bridging layer and the conductive-wire layer;

forming a patterned photo-resist layer on the transparent conductive layer;

removing a portion of the transparent conductive layer which is not covered by the photo-resist layer to form a touch-sensing conductive layer;

removing the photo-resist layer, so that the transparent conducting layer turns into a touch-sensing conducting layer; and

forming a protection layer on the substrate to cover the touch-sensing conductive layer and the bridging layer.

In one embodiment of the present invention, the bridging photo-resist layer is formed through a half-tone masking technique.

In one embodiment of the present invention, an angle between the bridging layer and a surface of the conductive-wire layer is smaller than an angle between a bottom surface and a top surface of the bridging layer passed through the baking process.

In one embodiment of the present invention, in the step of removing a portion of the conductive layer which is not covered by the bridging photo-resist layer to form a patterned conductive layer, an interval between the edge of the bridging photo-resist layer and the edge of the patterned conductive layer is less than 5 μm.

### DESCRIPTION OF THE DRAWINGS

FIG. 1 is a side view of conventional capacitive touch sensor structure;

FIG. 2 is a schematic diagram showing a conventional fabricating process of a touch sensor structure;

FIGS. 3a to 3f are flow diagrams showing a conventional process of manufacturing a touch sensor structure;

FIGS. 4a to 4d are flow diagrams following the process of FIG. 3f;

FIG. 5 is a schematic diagram showing a fabricating process of a touch sensor structure according to a preferred embodiment of the present invention;

FIGS. 6a to 6e are flow diagrams showing a method for fabricating a touch sensor structure according to a preferred embodiment of the present invention;

FIGS. 7a to 7d are flow diagrams following the process of FIG. 6e;

FIGS. 8a to 8d are flow diagrams showing an additional baking process according a preferred embodiment of the present invention;

FIG. 9 is a top view of a bridging layer and a conductive-wire layer according to a preferred embodiment of the present invention;

FIG. 10 is a schematic view showing an angle between the bridging layer and the conductive-wire layer according to a preferred embodiment of the present invention;

FIG. 11 is a schematic view showing an angle between a bottom surface and a top surface of the bridging layer before passing through the baking process according to a preferred embodiment of the present invention; and

FIG. 12 is a schematic view showing the angle between the bottom surface and the top surface of the bridging layer after passing through the baking process.

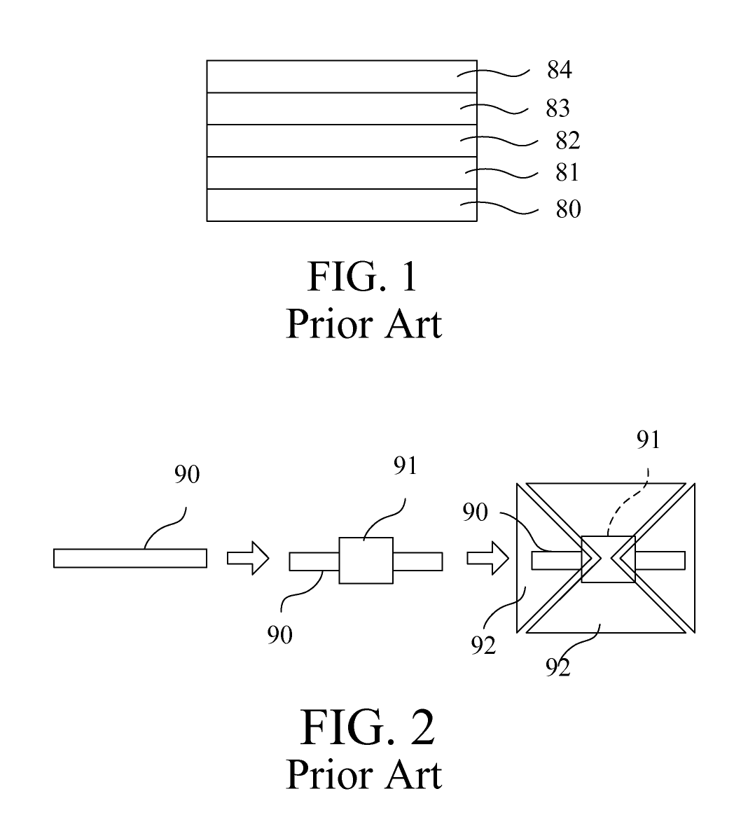

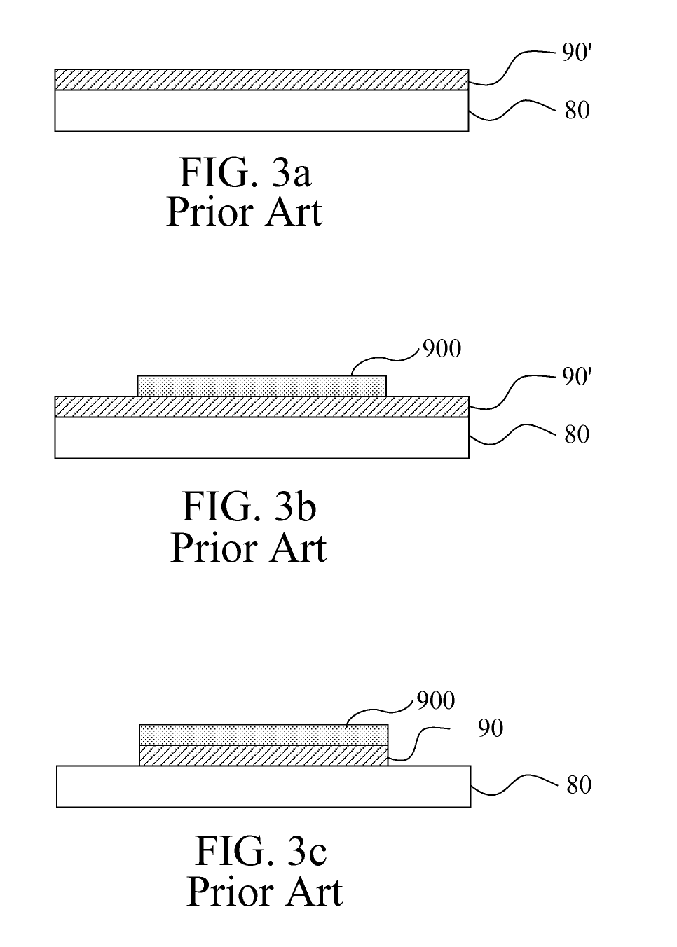

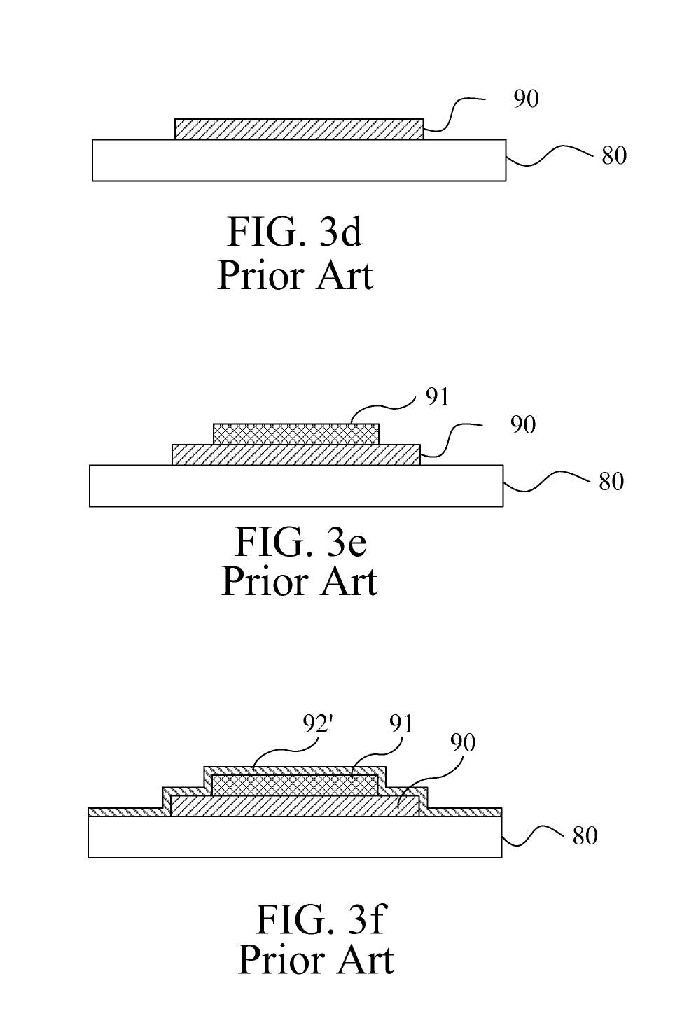

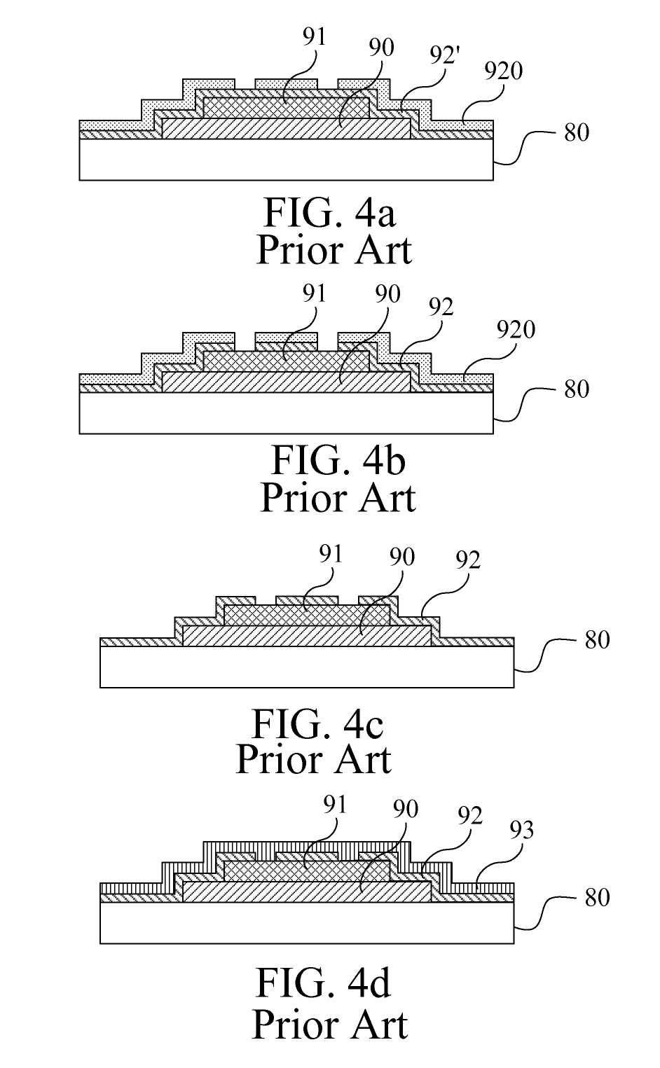

### DETAILED DESCRIPTION OF THE PREFERRED EMBODIMENTS

The foregoing objects, features and advantages adopted by the present invention can be best understood by referring to the following detailed description of the preferred embodiments and the accompanying drawings. Furthermore, the directional terms described in the present invention, such as upper, lower, front, rear, left, right, inner, outer, side and etc., are only directions referring to the accompanying drawings, so that the used directional terms are used to describe and understand the present invention, but the present invention is not limited thereto.

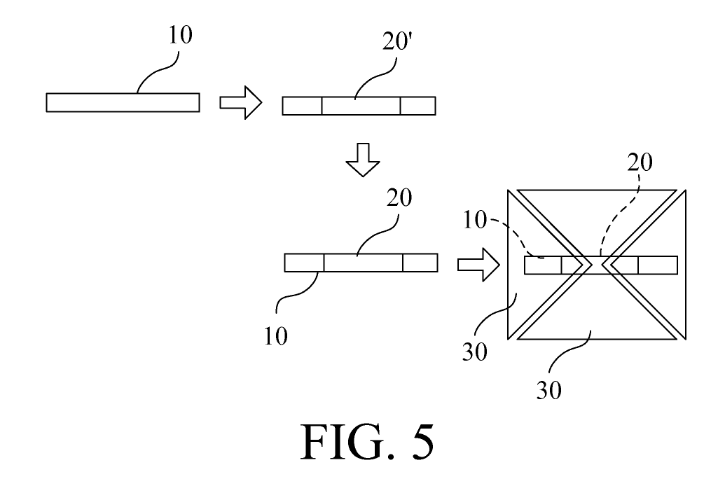

Please refer to FIG. 5, FIG. 5 discloses a schematic flow diagram showing a fabricating process of a touch sensor structure according to a preferred embodiment of the present invention. The fabricating processes of the touch sensor structure mainly comprises: forming a conductive-wire layer 10, forming a bridging layer 20 and forming a touch-sensing conductive layer 30.

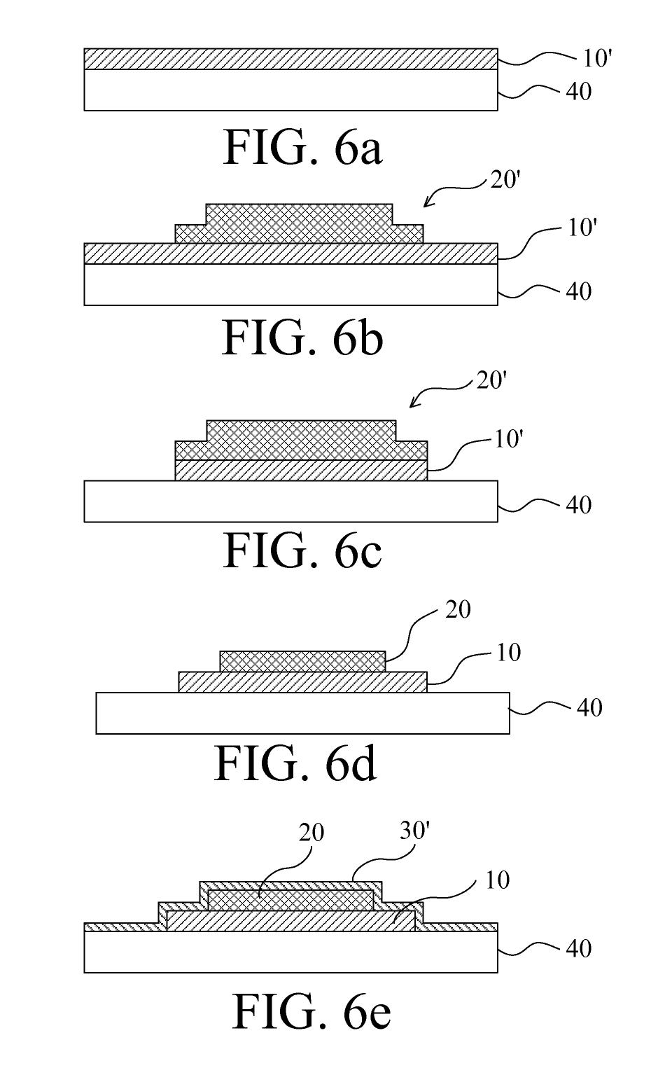

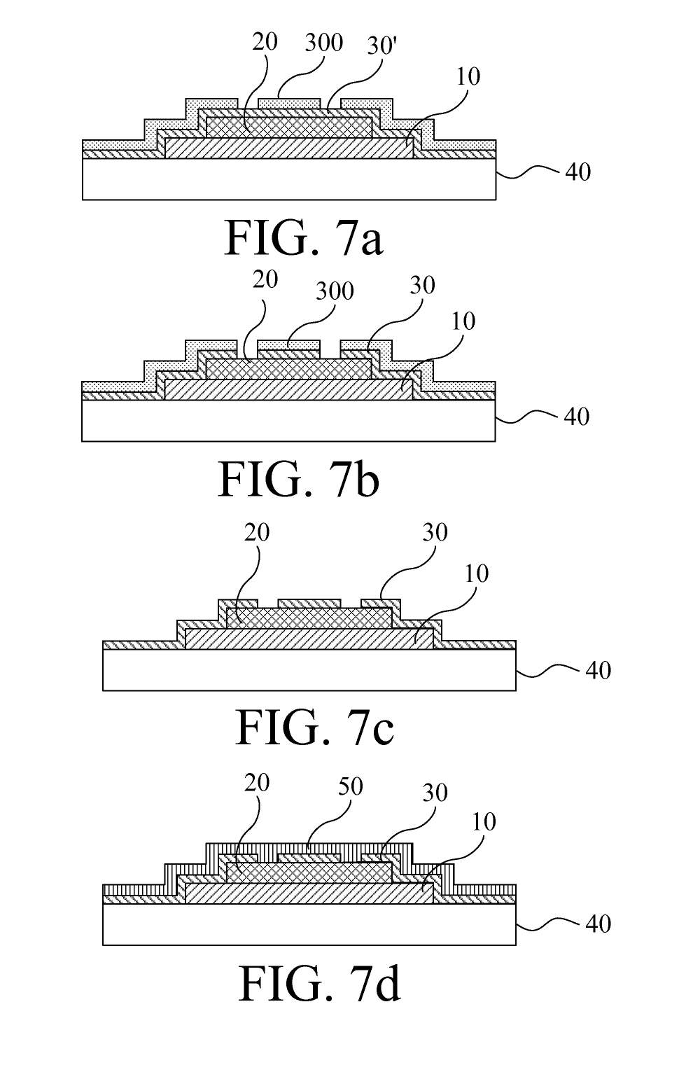

Further refer to FIGS. 6a to 6e and 7a to 7d, which disclose a method for fabricating a touch sensor structure according to a preferred embodiment of the present invention. The method of fabricating the touch sensor structure comprises steps of:

forming a conductive layer 10′ on a substrate 40 (as shown in FIG. 6a), wherein the means of forming the conductive layer 10′ may be metal sputtering;

forming a patterned bridging photo-resist layer 20′ on the conductive layer 10′, wherein the bridging photo-resist layer 20′ is formed through a half-tone masking exposure technique, which mainly uses a half-tone mask to perform exposure and development and thereby forms the bridging photo-resist layer 20′ with varied thicknesses, and the bridging photo-resist layer 20′ has a first portion and a second portion, wherein the thickness of the second portion is thinner than the thickness of the first portion (as shown in FIG. 6b);

removing a portion of the conductive layer 10′ which is not covered by the bridging photo-resist layer 20′ to form a patterned conductive layer 10′, that is, use the bridging photo-resist layer 20′ to pattern the conductive layer 10′ through a means of metal etching or the like (as shown in FIG. 6c), wherein an edge of the bridging photo-resist layer 20′ is substantially aligned with an edge of the patterned conductive layer 10′, and an interval between the edge of the bridging photo-resist layer 20′ and the edge of the pattern conductive layer 10′ is preferably less than 5 μm;

then executing a step of photo-resist stripping to remove a specific thickness of the bridging photo-resist layer 20′, that is, to remove the thinner second portion of the bridging photo-resist layer 20′, so that the patterned conductive layer 10′ is partially exposed to be a conductive-wire layer 10, and the thicker first portion of the bridging photo-resist layer 20′ is left to be as a bridging layer 20 (as shown in FIG. 6d);

then forming a transparent conductive layer 30′ on the substrate 40 to cover the bridging layer 20 and the conductive-wire layer 10 (as shown in FIG. 6e);

forming a patterned photo-resist layer 300 on the transparent conductive layer 30′ (as shown in FIG. 7a);

removing a portion of the transparent conductive layer 30′ that is not covered by the photo-resist layer 300, so that the transparent conductive layer 30′ is patterned to be as a touch-sensing conductive layer 30 (as shown in FIG. 7b);

removing the photo-resist layer 300 (as shown in FIG. 7c); and

forming a protection layer 50 on the substrate 40 to cover the touch-sensing conductive layer 30 and the bridging layer 20, and the fabricating process of the touch sensor structure of the present invention is finished (as shown in FIG. 7d).

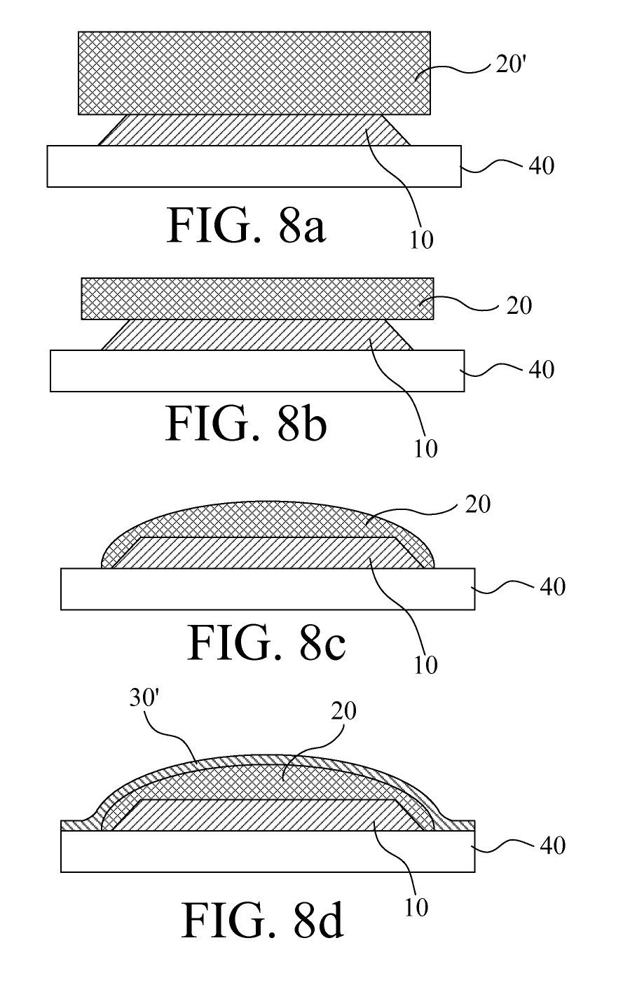

Furthermore, with reference to FIGS. 8a to 8d, FIGS. 8a and 8b are cross-sectional side views respectively showing before and after removing the second portion of the bridging photo-resist layer 20′. Since the edge of the bridging layer 20 is substantially aligned with a part of the edge of the conductive-wire layer 10, when the transparent conductive layer 30′ is formed thereon, the transparent conductive layer 30′ may be broken or make contact with the conductive-wire layer 10 lead to a short circuit due to the height difference by the bridging layer 20 and the conductive-wire layer 10. Hence, after the step of removing the second portion of the bridging photo-resist layer 20′ (that is, before forming the transparent conductive layer 30′), the present invention may further comprise the following step of:

softening the bridging layer 20 by a baking process (also called “thermal reflow”), so that the edge of the bridging layer 20 extends and covers the edge of the conductive-wire layer 10 (as shown in FIG. 8c).

With the foregoing baking process, the transparent conductive layer 30′ can be more smoothly formed on the bridging layer 20 and the conductive-wire layer 10 (as shown in FIG. 8d).

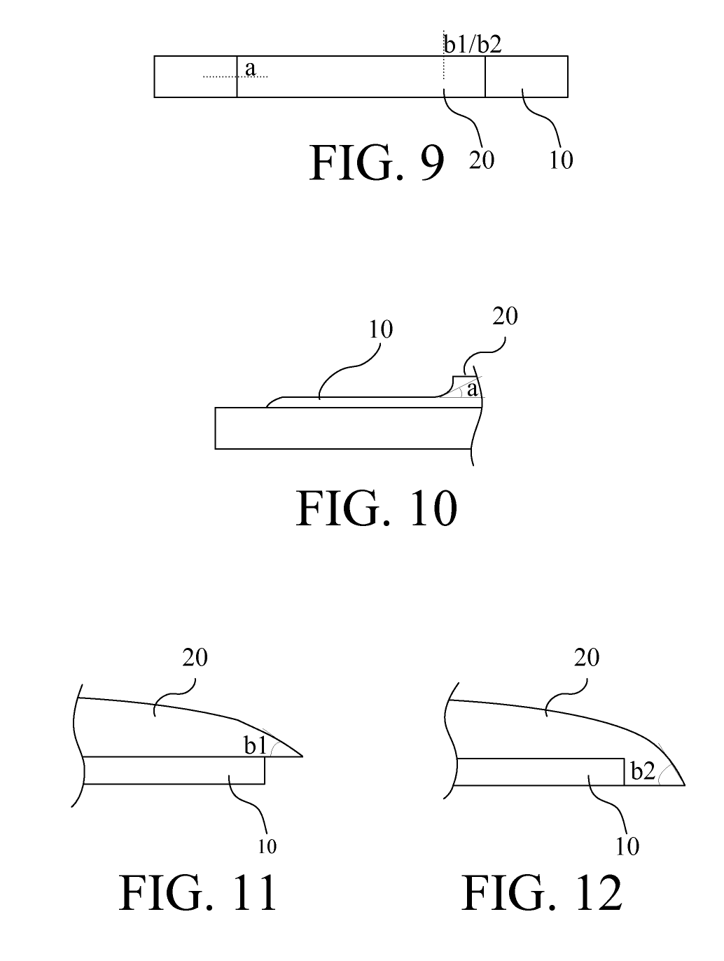

With reference to FIG. 9, which is a top view of the bridging layer 20 and the conductive-wire layer 10, wherein further refer to FIG. 10, an angle between the bridging layer 20 and a surface of the conductive-wire layer 10 is a; and further refer to FIGS. 11 and 12, which are schematic views showing an angle between a bottom surface and a top surface of the bridging layer 20 before and after passing through the baking process. Because the angle between the bottom surface and the top surface of the bridging layer 20 will become larger after the baking process, therefore the angle b2 between the bottom surface and the top surface after the baking process will be larger than the angle b1 between the bottom surface and the top surface before the baking process, and the angle a between the bridging layer and a surface of the conductive-wire layer 10 will be smaller than b1 and b2.

Since the present invention only requires a half-tone masking technique during forming the conductive-wire layer 10 and the bridging layer 20 to form the bridging photo-resist layer 20′, while comparing with the conventional method of fabricating the touch sensor structure, the present invention reduces one masking process and relatively has better production efficiency.

The present invention has been described with a preferred embodiment thereof and it is understood that many changes and modifications to the described embodiment can be carried out without departing from the scope and the spirit of the invention that is intended to be limited only by the appended claims.

What is claimed is:

1. A method for fabricating a touch sensor structure, comprising steps of:
forming a conductive layer on a substrate;
forming a bridging photo-resist layer on the conductive layer, wherein the bridging photo-resist layer partially covers the conductive layer, and the bridging photo-resist layer has a first portion and a second portion, and the thickness of the second portion is thinner than the thickness of the first portion;
removing the conductive layer which is not covered by the bridging photo-resist layer to form a patterned conductive layer, wherein an edge of the bridging photo-resist layer is substantially aligned with an edge of the patterned conductive layer;
removing the second portion of the bridging photo-resist layer to form a bridging layer and the patterned conductive layer is partially exposed to form a conductive-wire layer;
softening the bridging layer by a baking process;
forming a transparent conductive layer on the substrate to cover the bridging layer and the conductive-wire layer;
forming a patterned photo-resist layer on the transparent conductive layer;
removing the transparent conductive layer which is not covered by the photo-resist layer and then removing the photo-resist layer to form a touch-sensing conductive layer; and
forming a protection layer on the substrate to cover the touch-sensing conductive layer and the bridging layer.

2. The method for fabricating a touch sensor structure as claimed in claim 1, wherein the bridging photo-resist layer is formed through a half-tone masking technique.

3. The method for fabricating a touch sensor structure as claimed in claim 2, wherein an angle between the bridging layer and a surface of the conductive-wire layer is smaller than an angle between a bottom surface and a top surface of the bridging layer passed through the baking process.

4. The method for fabricating a touch sensor structure as claimed in claim 2, wherein in the step of removing the conductive layer which is not covered by the bridging photo-resist layer to form a patterned conductive layer, an interval between the edge of the bridging photo-resist layer and the edge of the patterned conductive layer is less than 5 μm.
